(19) United States
(12) Patent Application Publication
(10) Pub. No.: US 2014/0236853 A1
(43) Pub. Date: Aug. 21, 2014

(54) METHOD, DEVICE, AND SYSTEM FOR PROCESSING CONTACT INFORMATION

(71) Applicant: TENCENT TECHNOLOGY (SHENZHEN) COMPANY LIMITED, Shenzhen (CN)

(72) Inventor: ZHENZHEN JIANG, Shenzhen (CN)

(73) Assignee: TENCENT TECHNOLOGY (SHENZHEN) COMPANY LIMITED, Shenzhen (CN)

(21) Appl. No.: 14/230,254

(22) Filed: Mar. 31, 2014

Related U.S. Application Data
(63) Continuation of application No. PCT/CN2013/088340, filed on Dec. 2, 2013.

(30) Foreign Application Priority Data
Feb. 21, 2013 (CN) 2013100558494

(51) Int. Cl. G06Q 50/26

(52) U.S. Cl. CPC G06Q 50/265
USPC 705/325

(57) ABSTRACT

Methods, devices, and systems for processing contact information are provided. A request for generating virtual contact information can be received from a terminal. According to the request for generating virtual contact information, real contact information that is preset can be obtained. According to the real contact information, the virtual contact information can be generated. The virtual contact information can be sent to the terminal for a user to use.

### CROSS-REFERENCES TO RELATED APPLICATIONS

This application is a continuation application of PCT Patent Application No. PCT/CN2013/088340, filed on Dec. 2, 2013, which claims priority to Chinese Patent Application No. CN2013100558494, filed on Feb. 21, 2013, the entire contents of all of which are incorporated herein by reference.

### FIELD OF THE DISCLOSURE

The disclosure relates to the field of communication technology and, more particularly, relates to methods, devices, and systems for processing contact information.

### BACKGROUND

As the Internet provides great convenience to people's lives, hidden issues may occur regarding information security. For example, during an on-line shopping process, a buyer (or a user) may know nothing about the seller who is on the other side of the Internet, while the buyer usually has to provide their contact information (e.g., home address and/or mobile phone number) to the seller in order to accomplish the on-line shopping process. In some cases, such contact information may be illegally obtained and used by some people in illegal activities (e.g., in an illegal marketing or even swindling), which may adversely affect other people's (e.g., buyer's) normal life and/or their properties.

In addition, with the rapid development of the society, people's contact information may be changed more frequently than ever, and may not be timely updated for various reasons. Consequently, important mails or purchases may often be undesirably missed with unnecessary loss.

Existing techniques for processing contact information are not sufficiently flexible, which may have security issues on personal information, and may not timely update personal information.

### BRIEF SUMMARY OF THE DISCLOSURE

One aspect of the present disclosure includes a method for processing contact information. A request for generating virtual contact information sent from a terminal can be received. According to the request for generating virtual contact information, real contact information that is preset can be obtained. According to the real contact information, the virtual contact information can be generated. The virtual contact information can be sent to the terminal for a user to use.

Another aspect of the present disclosure includes a device for processing contact information. The device can include a receiving unit, an obtaining unit, a generating unit, and a sending unit. The receiving unit can be configured to receive a request for generating virtual contact information sent from a terminal. The obtaining unit can be configured to obtain real contact information that is preset, according to the request for generating virtual contact information. The generating unit can be configured to generate the virtual contact information according to the real contact information. The sending unit can be configured to send the virtual contact information to the terminal for a user to use.

Another aspect of the present disclosure includes a non-transitory computer-readable medium having computer program. When being executed by a processor, the computer program performs a method for processing contact information. The method includes receiving a request for generating virtual contact information sent from a terminal, obtaining real contact information that is preset, according to the request for generating virtual contact information, generating the virtual contact information according to the real contact information, and sending the virtual contact information to the terminal for a user to use.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 depicts an exemplary method for processing contact information in accordance with various disclosed embodiments;

FIG. 2a depicts another exemplary method for processing contact information in accordance with various disclosed embodiments;

FIG. 2b depicts another exemplary method for processing contact information in accordance with various disclosed embodiments;

FIG. 3 depicts another exemplary method for processing contact information in accordance with various disclosed embodiments;

FIG. 4 depicts an exemplary device for processing contact information in accordance with various disclosed embodiments;

FIG. 5 depicts an exemplary environment incorporating certain disclosed embodiments; and

FIG. 6 depicts an exemplary server consistent with the disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

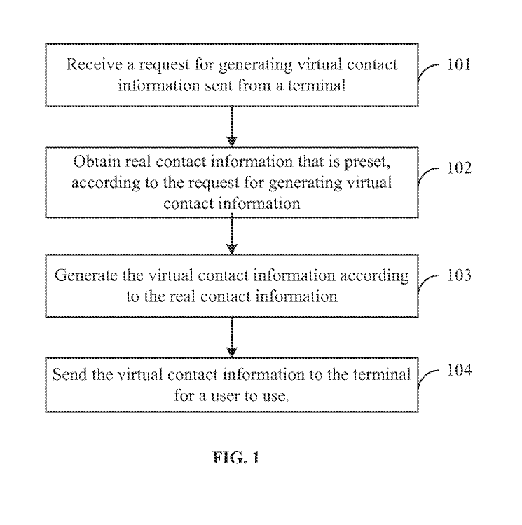

FIGS. 1-4 depict exemplary methods, devices, and communication systems for processing contact information in accordance with various disclosed embodiments. The exemplary methods, devices, and communication systems can be implemented in an exemplary environment 500 as shown in FIG. 5.

In FIG. 5, the environment 500 can include a server 504, a terminal 506, and a communication network 502. The server 504 and the terminal 506 may be coupled through the communication network 502 for information exchange, for example, Internet searching, webpage browsing, etc. Although only one terminal 506 and one server 504 are shown in the environment 500, any number of terminals 506 or servers 504 may be included, and other devices may also be included.

The communication network 502 may include any appropriate type of communication network for providing network connections to the server 504 and terminal 506 or among multiple servers 504 or terminals 506. For example, the communication network 502 may include the Internet or other types of computer networks or telecommunication networks, either wired or wireless.

A terminal, as used herein, may refer to any appropriate user terminal device with certain computing capabilities, for example, a personal computer (PC), a work station computer, a notebook computer, a car computer (e.g., carrying in a car or other vehicles), a server computer, a hand-held computing device (e.g., a tablet computer), a mobile terminal (e.g., a mobile phone, a smart phone, an iPad, and/or an aPad), a POS (i.e., point of sale) device, or any other user-side computing device.

A server, as used herein, may refer one or more server computers configured to provide certain server functionalities, for example, search engines and database management. A server may also include one or more processors to execute computer programs in parallel. Exemplary server can include an access server, an address server, an internet application server, etc.

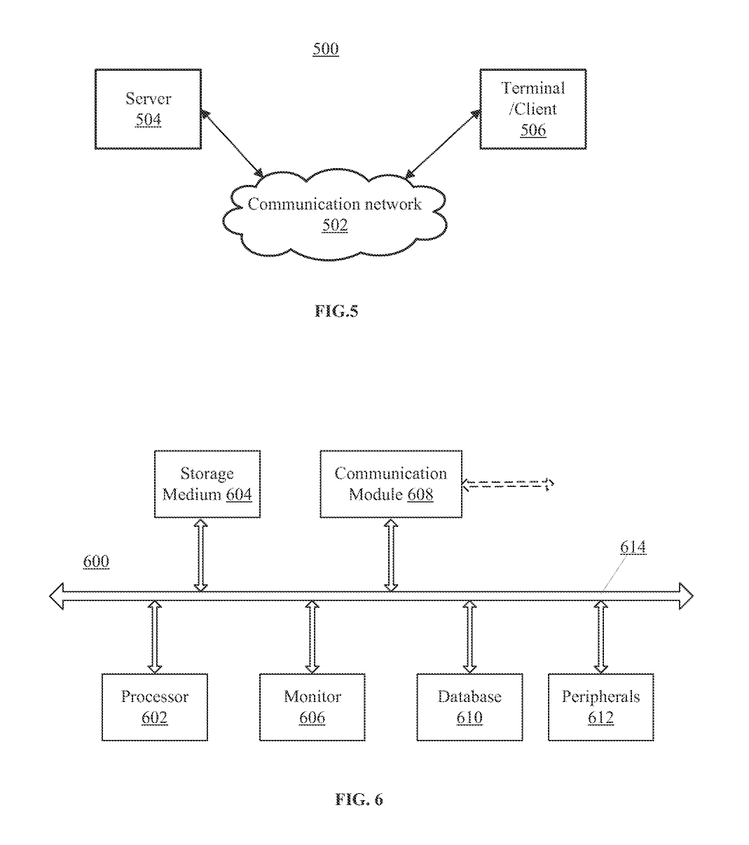

The server 504 and the terminal 506 may be implemented on any appropriate computing platform. FIG. 6 shows a block diagram of an exemplary computing system 600 capable of implementing the server 504 and/or the terminal 506. As shown in FIG. 6, the exemplary computer system 600 may include a processor 602, storage medium 604, a monitor 606, a communication module 608, a database 610, peripherals 612, and one or more bus 614 to couple the devices together. Certain devices may be omitted and other devices may be included.

The processor 602 can include any appropriate processor or processors. Further, the processor 602 can include multiple cores for multi-thread or parallel processing. The storage medium 604 may include memory modules, for example, ROM, RAM, and flash memory modules, and mass storages, for example, CD-ROM, U-disk, removable hard disk, etc. The storage medium 604 may store computer programs for implementing various processes, when executed by the processor 602.

Further, the peripherals 612 may include I/O devices, for example, keyboard and mouse, and the communication module 608 may include network devices for establishing connections through the communication network 502. The database 610 may include one or more databases for storing certain data and for performing certain operations on the stored data, for example, webpage browsing, database searching, etc.

In operation, the terminal 506 may cause the server 504 to perform certain actions, for example, an Internet search or other database operations. The server 504 may be configured to provide structures and functions for such actions and operations. More particularly, the server 504 may include a data searching system for real-time database searching. In various embodiments, a terminal, for example, a mobile terminal involved in the disclosed methods and systems can include the terminal 506.

As discussed above, exemplary terminal may include, for example, PCs (i.e., personal computer), tablet PCs, mobile phones, PDAs (i.e., personal digital assistant), e-readers, laptops, automotive terminals (e.g., terminals carried by motor vehicles) and/or other devices. In an exemplary embodiment, the browser can be a browser based on a webkit kernel, and the browser engine can be a JS (Java Script) engine. Exemplary JS browser engine can be a JSC (i.e., java script core, a kind of JavaScript engine) engine. The JSC engine can be contained in the webkit kernel of the browser. The browser can be installed on a terminal. As used herein, unless otherwise specified, a terminal can be referred to as a terminal installed with one or more browsers, a terminal containing installed browser(s), or a browser-installed-terminal.

Various embodiments provide methods, devices, and systems for processing contact information. A device for processing contact information is provided and can include, e.g., a server, a getaway, and/or other suitable devices. In one embodiment, an exemplary device for processing the contact information can include an access server, an address server, an address inquiry gateway, etc.

An exemplary method for processing contact information can include, for example, receiving a request for generating virtual contact information from a terminal; obtaining preset real contact information according to the request for generating virtual contact information; generating the virtual contact information according to the real contact information; and sending the virtual contact information to the terminal for a user to use.

FIG. 1 depicts an exemplary method for processing contact information in accordance with various disclosed embodiments.

In Step 101, a request for generating virtual contact information can be received from a terminal. For example, when a user is shopping online, the user may need to provide the seller with his/her contact information. The user may send a request for generating virtual contact information to a device for processing his/her contact information.

To increase personal information security, the request for generating virtual contact information can contain identity verification information to verify the validity of the user's identity.

The terminal may be a terminal device including, e.g., a mobile phone, a personal computer, tablet computer, etc. For example, the user may access services for processing his/her contact information, by using the terminal to log into websites, to load programs, or to use various applications (Apps) published by a mobile platform.

In Step 102, preset real contact information can be obtained according to the request for generating virtual contact information. The real contact information can be pre-stored in the device for processing the contact information by the user. That is, before the Step of “receiving the request for generating virtual contact information from the terminal”, the method may include: receiving the real contact information sent from the terminal, and storing the real contact information.

The real contact information can include information including, e.g., address and/or phone number, of the contact. In addition, the real contact information can include other information including, e.g., the user's gender, age, date of birth (DOB), and/or personal preference.

Further, when the request for generating virtual contact information contains identity verification information, the exemplary Step 102 of “obtaining the preset real contact information according to the request for generating virtual contact information” can include: obtaining the preset real contact information according to the request for generating virtual contact information, when a valid identity of the user is determined according to the identity verification information.

Otherwise, when an invalid identity of the user is determined according to the identity verification information, the disclosed method may include: refusing the request for generating virtual contact information to end the process. Meanwhile, in some cases, the user can be reminded with the refusing reasons.

In Step 103, the virtual contact information can be generated according to the obtained real contact information. For example, the obtained real contact information can be converted into the virtual contact information using a preset algorithm. The virtual contact information can include temporary virtual contact information or fixed virtual contact information. For example, the exemplary Step 103 can include, according to the real contact information, generating the temporary virtual contact information or generating the fixed virtual contact information.

In one embodiment, the contact information provided to the seller during an on-line shopping process can use the temporary virtual contact information, e.g., by generating virtual contact information for a one-time use. Because the temporary virtual contact information can only be used for one time, the seller cannot deliver other purchases to the buyer by re-filling or re-using the previous virtual contact information.

In another embodiment, for a user whose contact information is frequently changed, the user can apply for one or more fixed virtual contact information. Such fixed virtual contact information can be repeatedly used. In addition, the user can provide the fixed virtual contact information to reliable persons or organizations. In this manner, when user's real contact information has changed, the user can only need to update the real contact information corresponding to the fixed virtual contact information (which in the meanwhile modifies the contact information held by the persons and organizations), and thus timely update the contact information.

The virtual address can be in various forms including, e.g., a digital code denoted by a two-dimension barcode, and/or nay other suitable coding.

In Step 104, the virtual contact information can be sent to the terminal for the user to use. For example, during an on-line shopping process, the user may provide virtual contact information to the seller to avoid revealing his/her real contact information and to protect personal information security.

The user may also provide the fixed virtual contact information to reliable persons or organizations. In this manner, when user's real contact information has changed, the user can only need to update the real contact information corresponding to the fixed virtual contact information (which in the meanwhile modifies the contact information held by the persons and organizations), and thus timely update the contact information.

In addition, the method for processing contact information can include: receiving the virtual contact information from the terminal; converting the virtual contact information into the real contact information using the preset analytical algorithm; and sending the real contact information to the terminal.

For example, in an on-line shopping application, logistics providers may send virtual contact information via a terminal to a device for processing contact information, such that the device can use a preset analytical algorithm to convert the virtual contact information into real contact information. The real contact information can then be sent back to the logistics providers for the logistics providers to perform logistic distribution.

In another example, reliable persons or organizations of a user may send the virtual contact information via the terminal to the device for processing the contact information, such that the device can convert the virtual contact information into the real contact information via the preset analytical algorithm and then send the real contact information back to the reliable persons or organizations.

When the terminal sends the virtual contact information, identity verification information may be contained. In this case, the exemplary Step of “converting the virtual contact information into the real contact information via the preset analytical algorithm” can include: converting the virtual contact information into the real contact information via the preset analytical algorithm, when a valid identity of the user is determined according to the identity verification information. Otherwise, such exemplary Step can include: refusing to provide the real contact information to complete the process, when an invalid identity of the user is determined according to the identity verification information. Meanwhile, the user can be notified with the refusing reasons.

As such, the real contact information can only be obtained by specific persons and/or organizations. Personal information can thus be prevented from being revealed or illegally used. Security of personal information can be improved.

As disclosed, an exemplary method can include: receiving a request for generating virtual contact information from the terminal; obtaining preset real contact information according to the request for generating virtual contact information; generating the virtual contact information according to the real contact information; and sending the virtual contact information to the terminal for a user to use.

The user's contact information that is open to public is not the real contact information but the processed virtual contact information. In the case even if the virtual contact information is abused or stolen, the user would not be adversely affected. In addition, when the user needs to update the contact information, there is no need to update the contact information in a manner of one by one, because only the real contact information needs to be updated. In the other words, the disclosed methods can be used to increase information security, to reduce potential safety issues to the user due to information revealing, and to timely update the contact information in a simplified manner.

In another embodiment, an exemplary application scenario can include an on-line shopping process. An exemplary device for processing contact information can include an access server, an address server, and/or an address inquiry gateway.

The access server is configured to communicate with the terminal, e.g., to receive the request for generating virtual contact information from the terminal, according to the request for generating virtual contact information, to obtain the preset real contact information, and according to the real contact information, to generate the virtual contact information to provide to the terminal. In addition, the access server can further be configured to receive the real contact information from the terminal, and to send the real contact information to the address server.

In order for the users to use different terminals to conveniently manage the real contact information, the access server can adopt unified backstage interface and procedure. For example, the access server can adopt a web mode to provide service to the public, etc. At the same time, the access server can further undertake functions including, e.g., user identity verification, and/or other suitable functions.

The address server is configured to store and manage the real contact information of the users, e.g., to receive and store the real contact information sent from the access server. In addition, the address server can further be configured to receive management on the real contact information conducted by the users via the access server. Such management can include operations including, e.g., creating, deleting, adding, updating, and/or other operations.

The address inquiry gateway is configured to provide cooperative partners, such as logistics providers and/or shopping platforms, with services of obtaining and inquiring user data. For example, such services can include: according to the virtual contact information, obtaining the real contact information from the address server.

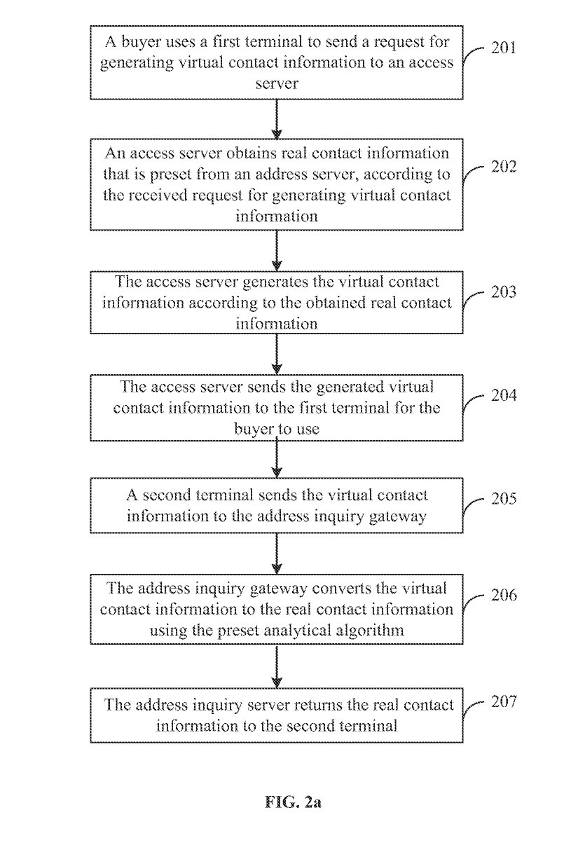

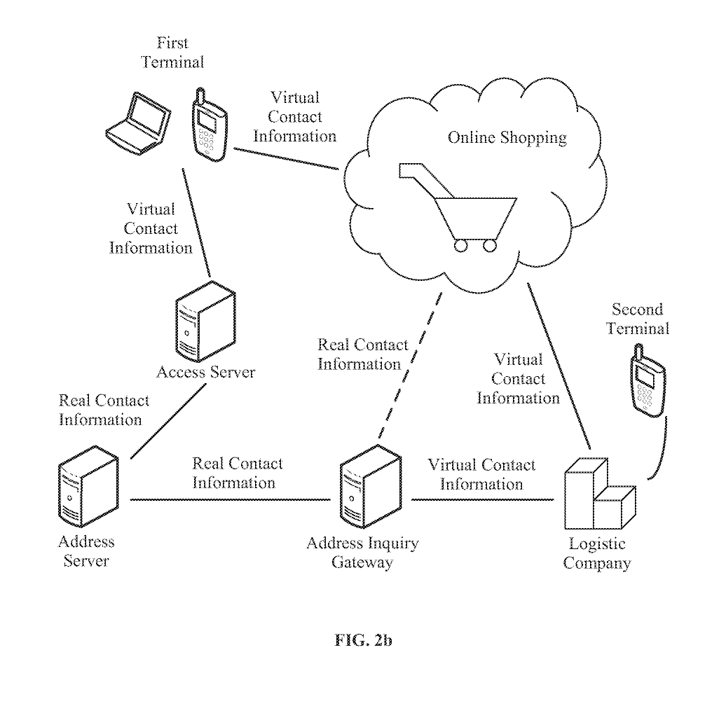

FIG. 2a depicts an exemplary method for processing contact information in accordance with various disclosed embodiments. For illustration purposes, a first terminal is a buyer's terminal, while a second terminal is a courier's terminal.

In Step 201, a buyer uses a first terminal to send a request for generating virtual contact information to an access server.

For example, when the buyer is shopping online, the buyer may need to provide the seller with his/her contact information. The buyer may send the request for generating virtual contact information to the access server to obtain the virtual contact information.

To increase personal information security, the request for generating virtual contact information can contain identity verification information to verify the validity of the buyer's identity.

The first terminal may be a terminal device including, e.g., a mobile phone, a personal computer, tablet computer, etc. For example, the user may access services for processing his/her contact information by using the terminal to log into websites, to load programs, or to use various applications (Apps) published by a mobile platform.

FIG. 2b depicts an exemplary method for processing contact information in accordance with various disclosed embodiments.

In Step 202, after an access server receives the request for generating virtual contact information, the access server obtains real contact information that is preset from the address server, according to the received request for generating virtual contact information.

The real contact information can be pre-stored in an address server by the user (e.g., the buyer). For example, the buyer may use the first terminal to send the real contact information to the address server, and to store and manage the real contact information by the address server.

The real contact information can include information including, e.g., address and/or phone number, of the contact. In addition, the real contact information can include other information including, e.g., the user's (buyer's) gender, age, date of birth (DOB), and/or personal preference.

Further, when the request for generating virtual contact information contains identity verification information, the access server may verify the request for generating virtual contact information, that is, the access server may determine whether the user identity is valid or invalid according to the identity verification information. When the access server determines that the user identity is valid, according to the request for generating virtual contact information, the access server obtains the preset real contact information from the address server. Otherwise, when the access server determines that the user identity is invalid, the request for generating virtual contact information is refused and the process ends. Meanwhile, in some cases, the user can be reminded with the refusing reasons.

In Step 203, the access server generates the virtual contact information according to the obtained real contact information. For example, the access server may convert the obtained real contact information into the virtual contact information using the preset analytical algorithm. The virtual contact information can include temporary virtual contact information or fixed virtual contact information.

In one embodiment, the contact information provided to the seller during an on-line shopping process can use the temporary virtual contact information, e.g., by generating virtual contact information for a one-time use. Because the temporary virtual contact information can only be used for one time, the seller cannot deliver other purchases to the buyer by re-filling or re-using the previous virtual contact information.

The virtual address can be in various forms including, e.g., a digital code denoted by a two-dimension barcode, and/or any other suitable coding. For example, a coding of LZOWIE384HFAEU2JAL etc. can be generated.

In Step 204, the access server sends the generated virtual contact information to the first terminal for the buyer to use. For example, the buyer can provide the virtual contact information to the seller in an on-line shopping process. The buyer can use the virtual contact information to replace the real contact information to fill the virtual contact information in a contact information bar, e.g., to fill the address of the virtual contact information in the address bar, or to fill the phone number of the virtual contact information into the contact number bar, or only fill a general virtual contact information without distinguishing anything, etc.

Then, when delivering the purchases to the buyer, the seller provides the virtual contact information of the buyer to the logistic company. Note that, the shopping platforms with close collaborations can be entitled to obtain some or all of the real contact information based on the virtual contact information, which can be specifically set up according to the needs of the practice application.

In Step 205, a second terminal sends the virtual contact information to the address inquiry gateway. For example, the logistic expressage may use the second terminal to send the virtual contact information to the address inquiry gateway. The second terminal may be a terminal device including, e.g., a mobile phone, a personal computer, a tablet computer, etc. Specifically, the logistic expressage may access services for processing his/her contact information by using the terminal to log into websites, to load programs, or to use various applications (Apps) published by a mobile platform.

When the second terminal uses the address inquiry gateway to send the virtual contact information, identity verification information can be contained.

Note that, the second terminal may not need to send the virtual contact information to the access server but to send the virtual contact information to the address inquiry gateway. In this case, the access server can also be configured to receive the virtual contact information sent from the receiving terminal (e.g., the second terminal), then to use a preset analytical algorithm to convert the virtual contact information to the real contact information, and to send the real contact information to the terminal (e.g., the second terminal). This process is described in Steps 206 and 207.

In Step 206, after receiving the virtual contact information, the address inquiry gateway converts the virtual contact information to the real contact information using the preset analytical algorithm. For example, the virtual contact information can be converted to the real contact information using the preset analytical algorithm via the inquire address server.

Note that, when the second terminal sends the virtual contact information that contains identity verification information, the user (e.g., courier) identity can be verified according to the identity verification information. When a valid identity of the user is determined, the virtual contact information is converted to the real contact information using the preset analytical algorithm. Otherwise, when an invalid identity of the user is determined, the real contact information is refused to be provided and the process is completed. Meanwhile, the user can be notified with the refusing reasons.

Note that, in Step 205, if the second terminal does not send the virtual contact information to the address inquiry gateway but send to the access server, the access server can convert the virtual contact information to the real contact information using the preset analytical algorithm. Like sending the virtual contact information to the address inquiry gateway, if the second terminal sends the virtual contact information that further contains the identity verification information, the access server may verify the user (e.g., the courier) identity according to the identity verification information. When a valid identity of the user is determined, the virtual contact information is converted to the real contact information using the preset analytical algorithm. Otherwise, when an invalid identity of the user is determined, the real contact information is refused to be provided and the process is completed. Meanwhile, the user can be notified with the refusing reasons.

In Step 207, the address inquiry server returns the real contact information to the second terminal. As such, the courier from the logistic company can distribute and deliver the purchases according to the obtained real contact information. The real contact information can only be obtained by specific persons and/or organizations. Personal information can thus be prevented from being revealed or illegally used. Security of personal information can be improved.

Note that, in step 205, if the access server receives the virtual contact information from the second terminal, the access server can return the real contact information to the second terminal.

As disclosed, the access server is configured to receive a request for generating virtual contact information from a first terminal; obtain preset real contact information according to the request for generating virtual contact information from the address server; generate the virtual contact information according to the real contact information; and send the virtual contact information to the first terminal for a buy to use. Subsequently, the second terminal is configured to obtain the real contact information by inquiring the address inquire gateway according to the virtual contact information.

In this manner, the buyer's contact information that is open to the public is not the real contact information but the processed virtual contact information. In the case even if the virtual contact information is abused or stolen, the buyer would not be adversely affected. In the other words, the disclosed devices can be used to increase information security, to reduce potential safety issues to the buyer due to information revealing, and to timely update the contact information in a simplified manner.

In one embodiment, an exemplary application scenario can include a process to provide the virtual contact information to reliable persons or organizations of a user. An exemplary device for processing contact information can include an access server, an address server, and/or an address inquiry gateway.

The access server is configured to communicate with the terminal, e.g., to receive the request for generating virtual contact information from the terminal, according to the request for generating virtual contact information, to obtain the preset real contact information, and according to the real contact information, to generate the virtual contact information to provide to the terminal. In addition, the access server can further be configured to receive the real contact information from the terminal, and to send the real contact information to the address server.

In order for the users to use different terminals to conveniently manage the real contact information, the access server can adopt unified backstage interface and procedure. For example, the access server can adopt a web mode to provide service to the public, etc. At the same time, the access server can further undertake functions including, e.g., user identity verification, and/or other suitable functions.

The address server is configured to store and manage the real contact information of the users, e.g., to receive and store the real contact information sent from the access server. In addition, the address server can further be configured to receive management on the real contact information conducted by the users via the access server. Such management can include operations including, e.g., creating, deleting, adding, updating, and/or other operations.

The address inquiry gateway is configured to provide cooperative partners, such as logistics providers and/or shopping platforms, with services of obtaining and inquiring user data. For example, such services can include: according to the virtual contact information, obtaining the real contact information from the address server.

FIG. 3 depicts an exemplary method for processing contact information in accordance with various disclosed embodiments. For illustration purposes, a first terminal is a terminal of a user, while a second terminal is a terminal for a person or an organization that the user trusts.

In Step 301, a user sends a request for generating virtual contact information via a first terminal to an access server. To increase personal information security, the request for generating virtual contact information can contain identity verification information to verify the validity of the user's identity.

The first terminal may be a terminal device including, e.g., a mobile phone, a personal computer, tablet computer, etc. For example, the user may access services for processing his/her contact information by using the terminal to log into websites, to load programs, or to use various applications (Apps) published by a mobile platform.

In Step 302, after the access server receives the request for generating virtual contact information, the access server obtains real contact information that is preset from the address server, according to the received request for generating virtual contact information.

The real contact information can be pre-stored in an address server by the user. For example, the user may use the first terminal to send the real contact information to the address server, and to store and manage the real contact information by the address server.

The real contact information can include information including, e.g., address and/or phone number, of the contact. In addition, the real contact information can include other information including, e.g., the user's gender, age, date of birth (DOB), and/or personal preference.

Further, when the request for generating virtual contact information contains identity verification information, the access server may verify the request for generating virtual contact information, that is, the access server may determine whether the user identity is valid or invalid according to the identity verification information. When the access server determines that the user identity is valid, according to the request for generating virtual contact information, the access server obtains the preset real contact information from the address server. Otherwise, when the access server determines that the user identity is invalid, the request for generating virtual contact information is refused and the process ends. Meanwhile, in some cases, the user can be reminded with the refusing reasons.

In Step 303, the access server generates the virtual contact information according to the obtained real contact information. For example, the access server may convert the obtained real contact information into the virtual contact information using the preset analytical algorithm. The virtual contact information can include temporary virtual contact information or fixed virtual contact information.

In another embodiment, for a user whose contact information is frequently changed, the user can apply for one or more fixed virtual contact information. Such fixed virtual contact information can be repeatedly used. In addition, the user can provide the fixed virtual contact information to reliable persons or organizations. In this manner, when user's real contact information has changed, the user can only need to update the real contact information corresponding to the fixed virtual contact information (which in the meanwhile modifies the contact information held by the persons and organizations), and thus timely update the contact information.

The virtual address can be in various forms including, e.g., a digital code denoted by a two-dimension barcode, and/or any other suitable coding. For example, a coding of LZOWIE384HFAEU2JAL etc. can be generated.

In Step 304, the access server sends the generated virtual contact information to the first terminal for the user to use. For example, the user may provide the virtual information to the persons and/or organizations that the user trusts.

In Step 305, a second terminal sends the virtual contact information to the address inquiry gateway. For example, the reliable persons and/or organizations may send the virtual contact information to the address inquiry gateway using the second terminal. The second terminal may be a terminal device including, e.g., a mobile phone, a personal computer, a tablet computer, etc.

When the second terminal uses the address inquiry gateway to send the virtual contact information, identity verification information can be contained.

Note that, the second terminal may not need to send the virtual contact information to the access server but to send the virtual contact information to the address inquiry gateway. In this case, the access server can also be configured to receive the virtual contact information sent from the receiving terminal (e.g., the second terminal), then to use a preset analytical algorithm to convert the virtual contact information to the real contact information, and to send the real contact information to the terminal (e.g., the second terminal). This process is described in Steps 306 and 307.

In Step 306, after receiving the virtual contact information, the address inquiry gateway converts the virtual contact information to the real contact information using the preset analytical algorithm. For example, the virtual contact information can be converted to the real contact information using the preset analytical algorithm via the inquire address server.

Note that, when the second terminal sends the virtual contact information that contains identity verification information, the user (e.g., persons and/or organizations) identity can be verified according to the identity verification information. When a valid identity of the user is determined, the virtual contact information is converted to the real contact information using the preset analytical algorithm. Otherwise, when an invalid identity of the user is determined, the real contact information is refused to be provided and the process is completed. Meanwhile, the user can be notified with the refusing reasons.

Note that, in Step 305, if the second terminal does not send the virtual contact information to the address inquiry gateway but send to the access server, the access server can convert the virtual contact information to the real contact information using the preset analytical algorithm.

Like sending the virtual contact information to the address inquiry gateway, if the second terminal sends the virtual contact information that further contains the identity verification information, the access server may verify the user (e.g., the courier) identity according to the identity verification information. When a valid identity of the user is determined, the virtual contact information is converted to the real contact information using the preset analytical algorithm. Otherwise, when an invalid identity of the user is determined, the real contact information is refused to be provided and the process is completed. Meanwhile, the user can be notified with the refusing reasons.

In Step 307, the address inquiry server returns the real contact information to the second terminal. As such, the reliable persons and/or organizations can receive the obtained real contact information.

When the user needs to update the contact information, i.e., to update the real contact information, only the real contact information stored on the address server needs to be updated. There is no need to update the contact information to the persons and/or organizations one after another. This can improve the processing of contact information and can timely update the contact information with significant convenience to the users.

Note that, in Step 305, if the access server receives the virtual contact information from the second terminal, the access server can return the real contact information to the second terminal.

As disclosed, the access server is configured to receive a request for generating virtual contact information from a first terminal; obtain preset real contact information according to the request for generating virtual contact information from the address server; generate the virtual contact information according to the real contact information; and send the virtual contact information to the first terminal for a user to use. Subsequently, the second terminal is configured to obtain the real contact information by inquiring the address inquire gateway according to the virtual contact information.

In this manner, the user's contact information that is open to the public is not the real contact information but the processed virtual contact information. In the case even if the virtual contact information is abused or stolen, the user would not be adversely affected. When the user needs to update the contact information, i.e., to update the real contact information, only the real contact information stored on the address server needs to be updated. There is no need to update the contact information to the persons and/or organizations one after another. In the other words, the disclosed devices can be used to increase information security, and to reduce potential safety issues to the user due to information revealing.

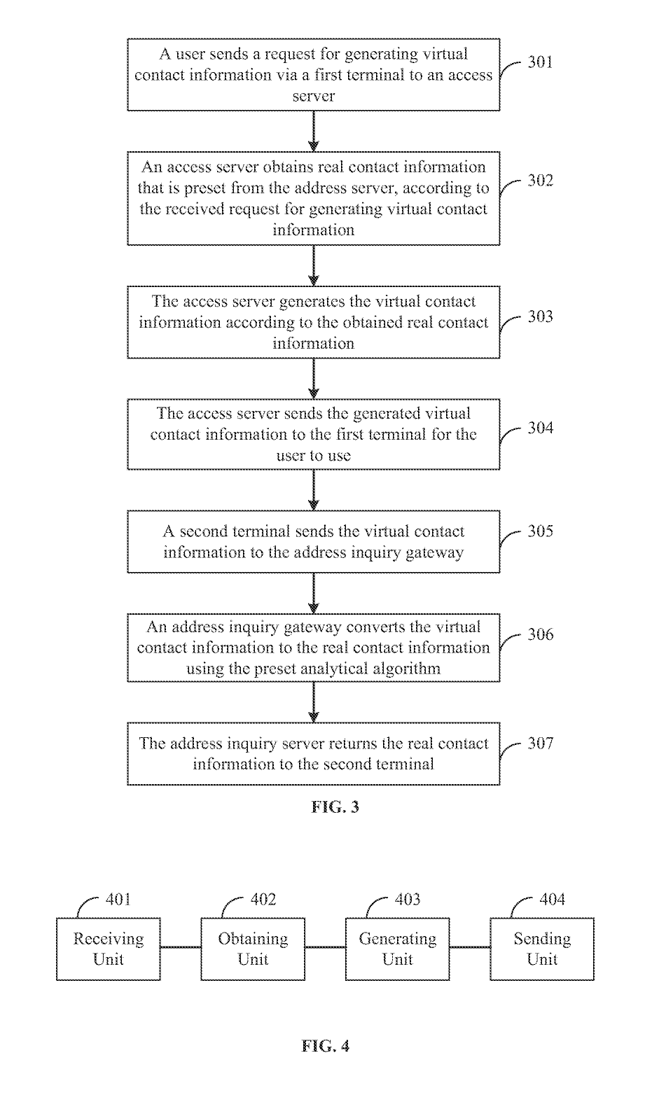

Various embodiments provide a device for processing the contact information. FIG. 4 depicts an exemplary device for processing contact information. The exemplary device includes a receiving unit 401, an obtaining unit 402, a generating unit 403, and/or a sending unit 404.

The receiving unit 401 is configured to receive the request for generating virtual contact information from the terminal. For example, when a user is shopping online, the user may need to provide the seller with his/her contact information. The user may send a request for generating virtual contact information to a device for processing his/her contact information.

The terminal may be a terminal device including, e.g., a mobile phone, a personal computer, a tablet computer, etc. For example, the user may access services for processing his/her contact information by using the terminal to log into websites, to load programs, or to use various applications (Apps) published by a mobile platform.

The obtaining unit 402 is configured to obtain the preset real contact information according to the request for generating virtual contact information received from the obtaining unit 402.

The real contact information can include information including, e.g., address and/or phone number, of the contact. In addition, the real contact information can include other information including, e.g., the user's gender, age, date of birth (DOB), and/or personal preference.

The generating unit 403 is configured to generate the virtual contact information according to the real contact information obtained by the obtaining unit 402. For example, the obtained real contact information can be converted to the virtual contact information using the preset analytical algorithm. The virtual address can be in various forms including, e.g., a digital code denoted by a two-dimension barcode, and/or any other suitable coding, etc.

The sending unit 404 is configured to send the virtual contact information generated by the generating unit 403 to the terminal for the user to use. For example, during an on-line shopping process, the user may provide virtual contact information to the seller to avoid revealing his/her real contact information and to protect personal information security.

The user may also provide the fixed virtual contact information to reliable persons or organizations. In this manner, when user's real contact information has changed, the user can only need to update the real contact information corresponding to the fixed virtual contact information (which in the meanwhile modifies the contact information held by the persons and organizations), and thus timely update the contact information.

The virtual contact information can include temporary virtual contact information or fixed virtual contact information.

The generating unit 403 is configured to generate the temporary virtual contact information according to the real contact information, or generate the fixed virtual contact information according to the real contact information.

In one embodiment, the contact information provided to the seller during an on-line shopping process can use the temporary virtual contact information. For example, the generating unit 403 can generate virtual contact information for a one-time use. Because the temporary virtual contact information can only be used for one time, the seller cannot deliver other purchases to the buyer by re-filling or re-using the previous virtual contact information.

In another embodiment, for a user whose contact information is frequently changed, the user can apply for one or more fixed virtual contact information, e.g., generated by the generating unit 403. Such fixed virtual contact information can be repeatedly used. In addition, the user can provide the fixed virtual contact information to reliable persons or organizations. In this manner, when user's real contact information has changed, the user can only need to update the real contact information corresponding to the fixed virtual contact information (which in the meanwhile modifies the contact information held by the persons and organizations), and thus timely update the contact information.

The real contact information can be pre-stored by the user in the device of processing contact information. Such device can thus include a storing unit. The receiving unit 401 is further configured to receive the real contact information from the terminal. The storing unit is configured to store the real contact information received from the receiving unit 401.

Optionally, to increase personal information security, the request for generating virtual contact information can contain identity verification information to verify the validity of the user's identity.

The receiving unit 401 is configured to receive the request for generating virtual contact information from the terminal. The request for generating virtual contact information can contain the identity verification information.

In this case, the generating unit 403 can be configured to obtain the preset real contact information, when a valid identity of the user is determined according to the identity verification information and according to the request for generating virtual contact information.

Otherwise, when an invalid identity of the user is determined according to the identity verification information, the generating unit 403 refuses the request for generating virtual contact information to complete the process. Meanwhile, in some cases, the user can be reminded with the refusing reasons.

In addition, the device of processing contact information further includes a converting unit. The receiving unit 401 is further configured to receive the virtual contact information from the terminal. The converting unit is configured to convert the virtual contact information into the real contact information using the preset analytical algorithm. The sending unit 404 is further configured to send the real contact information obtained by the converting unit to the terminal.

For example, in an on-line shopping application, logistics providers may use a terminal to send virtual contact information to the receiving unit 401 of the device for processing contact information, such that the converting unit can use a preset analytical algorithm to convert the virtual contact information into real contact information. The real contact information can then be sent back by the sending unit 404 to the logistics providers for the logistics providers to perform logistic distribution.

In another example, reliable persons and/or organizations of a user may use the terminal to send the virtual contact information to the receiving unit 401 of the device for processing contact information, such that the converting unit of the device can convert the virtual contact information into the real contact information using the preset analytical algorithm. The sending unit 404 can then send the real contact information back to the reliable persons and/or organizations.

Likewise, when the terminal sends the virtual contact information that can contain the identity verification information, the virtual contact information can be converted to the real contact information using the preset analytical algorithm, according to the identity verification information and when a valid identity of the user is determined. Otherwise, when an invalid identity of the user is determined, the real contact information is refused to be provided and the process is completed. Meanwhile, the user can be notified with the refusing reasons.

For example, the converting unit can be further configured to convert the virtual contact information to the real contact information via the preset analytical algorithm, when using the identity verification information to determine a valid identity of a user.

The converting unit can be specifically configured, when using the identity verification information to determine an invalid identity of a user, to refuse to provide the real contact information, and meanwhile to notify reasons for refusing.

As such, the real contact information can only be obtained by specific persons and/or organizations. Personal information can thus be prevented from being revealed or illegally used. Security of personal information can be improved.

In practice, each unit of the above may be individually used and/or combined into one or more unit to use. For example, the server and/or gateway can include an access server, an address server, and/or an address inquiry gateway.

As disclosed, the receiving unit 401 of the device for processing contact information receives a request for generating virtual contact information from the terminal; the obtaining unit 402 obtains preset real contact information according to the request for generating virtual contact information; the generating unit 403 generates the virtual contact information according to the real contact information; and sending unit 404 sends the virtual contact information to the terminal for a user to use.

The user's contact information that is open to the public is not the real contact information but the processed virtual contact information. In the case even if the virtual contact information is abused or stolen, the user would not be adversely affected. In addition, when the user needs to update the contact information, there is no need to update the contact information in a manner of one by one, because only the real contact information needs to be updated. In the other words, the disclosed methods can be used to increase information security, to reduce potential safety issues to the user due to information revealing, and to timely update the contact information in a simplified manner.

Accordingly, a communication system is provided. An exemplary communication system can include, e.g., a device for processing contact information as disclosed herein.

The device for processing contact information is configured to receive a request for generating virtual contact information from a terminal; according to the request for generating virtual contact information, to obtain the preset real contact information; and according to the real contact information, to generate the virtual contact information to provide to the terminal for the user to use.

For example, the obtained real contact information can be converted into the virtual contact information using the preset arithmetic. The virtual contact information can include temporary virtual contact information or fixed virtual contact information. The virtual address can be in various forms including, e.g., a digital code denoted by a two-dimension barcode, and/or any other suitable coding.

The device for processing contact information is further configured to receive the virtual contact information from the terminal, convert the virtual contact information into the real contact information using the preset analytical algorithm, and send the real contact information to the terminal.

The real contact information can be pre-stored by the user in the device of processing contact information. The device for processing contact information is further configured to receive the real contact information from the terminal, and to store the real contact information.

The real contact information can include information including, e.g., address and/or phone number, of the contact. In addition, the real contact information can include other information including, e.g., the user's gender, age, date of birth, and/or personal preference.

To increase personal information security, the request for generating virtual contact information can contain identity verification information to verify the validity of the user's identity. In an embodiment when the request for generating virtual contact information contains the identity verification information, the device for processing contact information can be specifically configured to obtain the preset real contact information, when using the identity verification information to determine a valid identity of a user and according to the request for generating virtual contact information.

Otherwise, when an invalid identity of the user is determined according to the identity verification information, the request for generating virtual contact information can be refused and the process can be completed. Meanwhile, in some cases, the user can be reminded with the refusing reasons.

In addition, the communication system can further include the terminal. The terminal can be configured to send the request for generating virtual contact information to the device for processing contact information, and to receive the virtual contact information returned from the device.

The terminal can further be configured to send the virtual contact information to the device for processing contact information, and to receive the real contact information returned from the device for processing contact information.

The device for processing contact information can be a device including server and/or gateway. For example, the device for processing contact information can be an access server, an address server, an address inquiring gateway etc. The terminal can include, e.g., a mobile phone, a personal computer, a tablet computer, etc. For example, the user may access services for processing his/her contact information, by using the terminal to log into websites, to load programs, or to use various applications (Apps) published by a mobile platform.

As disclosed, the device for processing contact information in the communication system can receive a request for generating virtual contact information from the first terminal; obtain preset real contact information according to the request for generating virtual contact information; generate the virtual contact information according to the real contact information; and send the virtual contact information to the first terminal for a user to use.

The user's contact information that is open to the public is not the real contact information but the virtual contact information after processing. In the case even if the virtual contact information is abused or stolen, the user would not be adversely affected. In addition, when the user needs to update the contact information, there is no need to update the contact information in a manner of one by one, because only the real contact information needs to be updated. In the other words, the disclosed methods can be used to increase information security, to reduce potential safety issues to the user due to information revealing, and to timely update the contact information in a simplified manner.

Various embodiments also provide a computer storage medium. The computer storage medium may store a program. Execution of the program includes some or all of the steps of the exemplary methods for implementing internet applications as disclosed herein.

The term “code”, as used herein, may include software, firmware, and/or microcode, and may refer to programs, routines, functions, classes, and/or objects.

The modules included herein are described according to their functional logic, but are not limited to the above descriptions as long as the modules can implement corresponding functions. Further, the specific name of each functional module is used for distinguishing from on another without limiting the protection scope of the present disclosure. In various embodiments, the disclosed modules can be configured in one apparatus or configured in multiple apparatus as desired. The modules disclosed herein can be integrated in one module or in multiple modules. Each of the modules disclosed herein can be divided into one or more sub-modules, which can be recombined in any manner.

Note that suitable software and/or hardware (e.g., a universal hardware platform) may be included and used in the disclosed methods and systems. For example, the disclosed embodiments can be implemented by hardware only, which alternatively can be implemented by software products only. The software products can be stored in a computer-readable storage medium including, e.g., ROM/RAM, magnetic disk, optical disk, etc. The software products can include suitable commands to enable a terminal device (e.g., including a mobile phone, a personal computer, a server, or a network device, etc.) to implement the disclosed embodiments.

The term “comprising”, “including” or any other variants thereof are intended to cover a non-exclusive inclusion, such that the process, method, article, or apparatus containing a number of elements also include not only those elements, but also other elements that are not expressly listed; or further include inherent elements of the process, method, article or apparatus. Without further restrictions, the statement “includes a” does not exclude other elements included in the process, method, article, or apparatus having those elements.

The terminology used in the description of the invention herein is for the purpose of describing particular examples only and is not intended to be limiting of the invention. As used in the description of the invention and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

The terminology used in the description of the invention herein is for the purpose of describing particular examples only and is not intended to be limiting of the invention. As used in the description of the invention and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items.

The embodiments disclosed herein are exemplary only. The order by which the foregoing examples of the present disclosure are presented merely reflects the convenience of description. It does not imply the preference among the examples. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

Methods, devices, and systems for processing contact information are provided. A request for generating virtual contact information can be received from a terminal. According to the request for generating virtual contact information, real contact information that is preset can be obtained. According to the real contact information, the virtual contact information can be generated. The virtual contact information can be sent to the terminal for a user to use.

As disclosed, the user's contact information that is open to the public is not the real contact information but the virtual contact information after processing. In the case even if the virtual contact information is abused or stolen, the user would not be adversely affected. In addition, when the user needs to update the contact information, there is no need to update the contact information in a manner of one by one, because only the real contact information needs to be updated. In the other words, the disclosed methods can be used to increase information security, to reduce potential safety issues to the user due to information revealing, and to timely update the contact information in a simplified manner.

What is claimed is:

1. A method for processing contact information, comprising:
receiving a request for generating virtual contact information sent from a terminal;
obtaining real contact information that is preset, according to the request for generating virtual contact information;
generating the virtual contact information according to the real contact information; and
sending the virtual contact information to the terminal for a user to use.

2. The method according to claim 1, further comprising:
receiving the virtual contact information sent from the terminal;
converting the virtual contact information into the real contact information using a preset analytical algorithm; and
sending the real contact information to the terminal.

3. The method according to claim 2, wherein, before receiving the request for generating virtual contact information, the method further includes:
receiving the real contact information sent from the terminal; and
storing the real contact information.

4. The method according to the claim 2, wherein generating the virtual contact information according to the real contact information includes:
generating temporary virtual contact information according to the real contact information; or
generating fixed virtual contact information according to the real contact information.

5. The method according to claim 2, wherein the request for generating virtual contact information contains identity verification information, and wherein obtaining the real contact information includes:
obtaining the real contact information according to the request for generating virtual contact information, when a valid identity of the user is determined according to the identity verification information.

6. A device for processing contact information, comprising:
a receiving unit, configured to receive a request for generating virtual contact information sent from a terminal;
an obtaining unit, configured to obtain real contact information that is preset, according to the request for generating virtual contact information;
a generating unit, configured to generate the virtual contact information according to the real contact information; and
a sending unit, configured to send the virtual contact information to the terminal for a user to use.

7. The device according to claim 6, further including a converting unit, wherein the receiving unit is further configured to receive the virtual contact information from the terminal; and the converting unit is configured to convert the virtual contact information into the real contact information using a preset analytical algorithm.

8. The device according to claim 7, further including a storing unit, wherein the receiving unit is further configured to receive the real contact information from the terminal, and the storing unit is configured to store the real contact information.

9. The device according to claim 7, wherein the generating unit is configured to generate temporary virtual contact information or generate fixed virtual contact information, according to the real contact information.

10. The device according to the claim 7, wherein the request for generating virtual contact information contains identity verification information; wherein the obtaining unit is configured to obtain the real contact information according to the request for generating virtual contact information, when a valid identity of the user is determined according to the identity verification information; and wherein the sending unit is configured to send the real contact information to the terminal.

11. A communication system comprising the device according to claim 6.

12. A non-transitory computer-readable medium having computer program for, when being executed by a processor, performing a method for processing contact information, the method comprising:
receiving a request for generating virtual contact information sent from a terminal;
obtaining real contact information that is preset, according to the request for generating virtual contact information;
generating the virtual contact information according to the real contact information; and
sending the virtual contact information to the terminal for a user to use.

13. The non-transitory computer-readable medium according to claim 12, the method further comprising:
receiving the virtual contact information sent from the terminal;
converting the virtual contact information into the real contact information using a preset analytical algorithm; and
sending the real contact information to the terminal.

14. The non-transitory computer-readable medium according to claim 13, wherein, before receiving the request for generating virtual contact information, the method further includes:
receiving the real contact information sent from the terminal; and
storing the real contact information.

15. The non-transitory computer-readable medium according to the claim 13, wherein generating the virtual contact information according to the real contact information includes:
generating temporary virtual contact information according to the real contact information; or
generating fixed virtual contact information according to the real contact information.

16. The non-transitory computer-readable medium according to claim 13, wherein the request for generating virtual contact information contains identity verification information, and wherein obtaining the real contact information includes:
obtaining the real contact information according to the request for generating virtual contact information, when a valid identity of the user is determined according to the identity verification information.
